(19) United States
(12) Patent Application Publication
(10) Pub. No.: US 2025/0350882 A1
(43) Pub. Date: Nov. 13, 2025

(54) VIBRATION DAMPING LOUDSPEAKER

(71) Applicant: FORTUNE GRAND TECHNOLOGY INC., Taoyuan City (TW)

(72) Inventors: PEI-JUNG LEE, Taoyuan City (TW); YU-HSI CHEN, Taoyuan City (TW); JIAN LV, Taoyuan City (TW); SHEN-YONG WEN, Taoyuan City (TW); MING-JUN ZENG, Taoyuan City (TW); XIAO SHI, Taoyuan City (TW)

(73) Assignee: FORTUNE GRAND TECHNOLOGY INC., Taoyuan City (TW)

(21) Appl. No.: 19/189,297

(22) Filed: Apr. 25, 2025

(30) Foreign Application Priority Data
May 10, 2024 (CN) 202421016104.7

(51) Int. Cl. H04R 1/28; H04R 7/12; H04R 9/02; H04R 9/04; H04R 9/06

(52) U.S. Cl. CPC H04R 1/2896; H04R 7/12; H04R 9/025; H04R 9/046; H04R 9/06

(57) ABSTRACT

A vibration damping loudspeaker includes a thin elongated speaker base, a vibration diaphragm, a voice coil, a magnetic assembly and a metal damper. In the vibration damping loudspeaker according to the present disclosure, the metal damper is utilized to increase the bearing power, so as to achieve a good shock-absorbing effect. Therefore, distortion such as skewing and polarization of the vibration diaphragm and the voice coil in high-power output may be avoided.

### CROSS-REFERENCE TO RELATED APPLICATION

This non-provisional application claims priority under 35 U.S.C. § 119(a) on Patent Application No(s). 202421016104.7 filed in China on May 10, 2024, the entire contents of which are hereby incorporated by reference.

### BACKGROUND OF THE INVENTION

### 1. Field of the Invention

The present disclosure provides a vibration damping loudspeaker, and in particular to a vibration damping loudspeaker which may increase the bearing power to achieve a good shock-absorbing effect, so as to avoid skewing, polarization and distortion of a vibration diaphragm and a voice coil in high-power output.

### 2. Description of the Related Art

For current general thin elongated speakers, due to direct contact between the voice coil and the vibration diaphragm and high height of the voice coil, when the speaker is in high power output, the vibration diaphragm and the voice coil are often distorted due to the high power output, such as skewing and polarization.

Therefore, how to invent a vibration damping loudspeaker which may increase the bearing power to achieve a good shock-absorbing effect, so as to avoid distortion such as skewing and polarization and distortion of the vibration diaphragm and the voice coil in high-power output is the point to be actively disclosed in the present disclosure.

### BRIEF SUMMARY OF THE INVENTION

In view of the above shortcomings, the inventor supposed to achieve a perfect solution and taken a deep study and finally developed a vibration damping loudspeaker which may increase the bearing power to achieve a good shock-absorbing effect, so as to avoid distortion such as skewing and polarization and distortion of the vibration diaphragm and the voice coil in high-power output.

To achieve above objective and other objectives, the present disclosure provides a vibration damping loudspeaker, which includes: a thin elongated speaker base, a vibration diaphragm, a voice coil, a magnetic assembly and a metal damper. The vibration diaphragm is arranged on the thin elongated speaker base. The voice coil includes a coil, a bobbin and two tinsel wires, where the coil is wound around the bobbin, the tinsel wires are electrically connected to the coil, and the bobbin is connected to the vibration diaphragm. The magnetic assembly includes a magnetic base and a magnetic unit, the magnetic unit is arranged on the magnetic base, and the voice coil is movably arranged outside the magnetic unit. The metal damper is connected to the thin elongated speaker base and the magnetic assembly, and the metal damper includes a central portion, two positioning portions and multiple elastic arms, where the central portion is arranged on the magnetic base, the positioning portions are arranged on two sides of the thin elongated speaker base, the elastic arms are arranged between the central portion and the positioning portions, and the positioning portions and the elastic arms are symmetrically arranged on two sides of the central portion.

In one embodiment of the present disclosure, each of two sides of the thin elongated speaker base is provided with an assembling portion, and the positioning portions are respectively arranged at the assembling portions.

In one embodiment of the present disclosure, each of the two sides of the thin elongated speaker base is provided with a protrusion, each of the positioning portions is provided with a notch, and the positioning portions are respectively arranged at the protrusions of the assembling portions through the notches.

In one embodiment of the present disclosure, each of the two sides of the thin elongated speaker base is provided with at least one auxiliary positioning column, each of the positioning portions is provided with at least one auxiliary positioning notch, and each auxiliary positioning column is arranged at the corresponding auxiliary positioning notch.

In one embodiment of the present disclosure, the metal damper is made of a stainless steel material, a beryllium copper alloy material or a carbon steel material.

In one embodiment of the present disclosure, the central portion is in a shape of a hollow ring, and is arranged at a bottom of the magnetic base.

In one embodiment of the present disclosure, the central portion is in a shape of a hollow ring, a bottom of the magnetic base is provided with an annular limiting portion, and the central portion is arranged at the annular limiting portion.

In one embodiment of the present disclosure, the central portion is in a shape of a hollow ring, a periphery of a bottom of the magnetic base is provided with an annular extending portion, and the central portion is arranged at the annular extending portion.

In one embodiment of the present disclosure, the central portion is annular or solid, and the metal damper is integrally formed or formed by two symmetrical bodies which are mutually connected.

In one embodiment of the present disclosure, each of the elastic arms is provided with a bending portion, each bending portion is S-shaped, and one end of each elastic arm is connected to the central portion while the other end thereof is connected to the corresponding positioning portion.

In one embodiment of the present disclosure, an included angle between a joint of each elastic arm to the central portion and a horizontal axis of rectangular coordinates is 40-60°.

In one embodiment of the present disclosure, each of the two sides of the thin elongated speaker base is provided with at least one positioning column, each of the positioning portions is provided with at least one positioning hole, and each positioning column is arranged in the corresponding positioning hole.

In one embodiment of the present disclosure, each positioning column is a hot melting column used for covering the corresponding positioning hole.

In one embodiment of the present disclosure, each of the two sides of the thin elongated speaker base is provided with a positioning retaining wall, each of the positioning portions is provided with a positioning notch, the positioning retaining walls are arranged at the positioning notches, and the positioning retaining walls are hot melting retaining walls used for covering the positioning notches.

In one embodiment of the present disclosure, a metal sheet is injection-molded on each of the two sides of the thin elongated speaker base, and each of the positioning portions is spot-welded to the corresponding metal sheet by laser.

In one embodiment of the present disclosure, a material of each metal sheet is the same as that of each positioning portion.

In the vibration damping loudspeaker according to the present disclosure, the metal damper is utilized to increase the bearing power, so as to achieve a good shock-absorbing effect. Therefore, distortion such as skewing and polarization of the vibration diaphragm and the voice coil in high-power output may be avoided.

### BRIEF DESCRIPTION OF THE DRAWINGS

FIG. 1 is an outside view 1 according to an Embodiment 1 of the present disclosure.

FIG. 2 is an outside view 2 according to an Embodiment 1 of the present disclosure.

FIG. 3 is a schematic exploded diagram 1 according to an Embodiment 1 of the present disclosure.

FIG. 4 is a schematic exploded diagram 2 according to an Embodiment 1 of the present disclosure.

FIG. 5 is a schematic bottom diagram according to an Embodiment 1 of the present disclosure.

FIG. 6 is a schematic sectional diagram according to an Embodiment 1 of the present disclosure.

FIG. 7 is a schematic exploded diagram according to an Embodiment 2 of the present disclosure.

FIG. 8 is a schematic sectional diagram according to an Embodiment 2 of the present disclosure.

FIG. 9 is a schematic bottom diagram according to an Embodiment 3 of the present disclosure.

FIG. 10 is a schematic sectional diagram according to an Embodiment 3 of the present disclosure.

FIG. 11 is a schematic exploded diagram according to an Embodiment 4 of the present disclosure.

FIG. 12 is an outside view according to an Embodiment 4 of the present disclosure.

FIG. 13 is a schematic exploded diagram according to an Embodiment 5 of the present disclosure.

FIG. 14 is an outside view according to an Embodiment 5 of the present disclosure.

FIG. 15 is a schematic partially enlarged diagram according to an Embodiment 5 of the present disclosure.

FIG. 16 is a schematic exploded diagram according to an Embodiment 6 of the present disclosure.

FIG. 17 is an outside view according to an Embodiment 6 of the present disclosure.

### DETAILED DESCRIPTION OF THE INVENTION

To fully understand the objectives, features and benefits of the present disclosure, detailed descriptions are provided below through specific embodiments and in conjunction with the accompanying drawings.

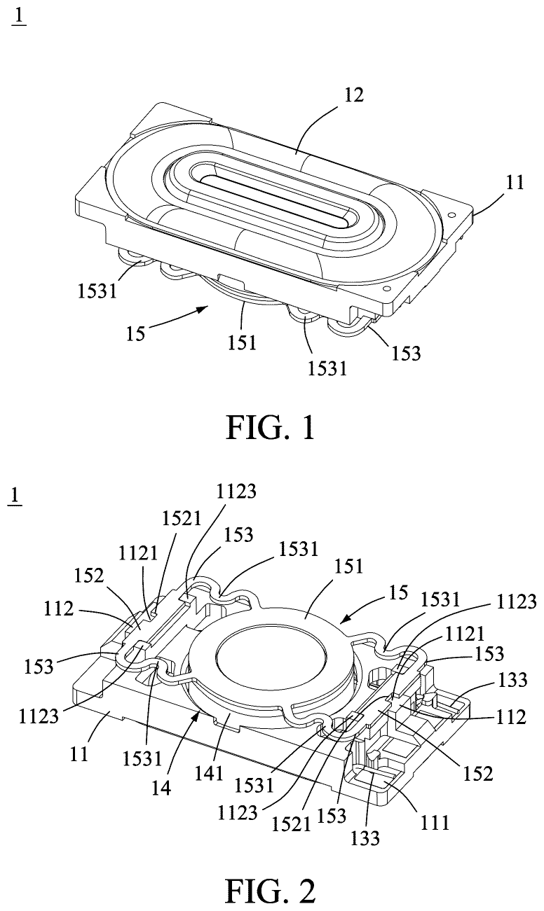

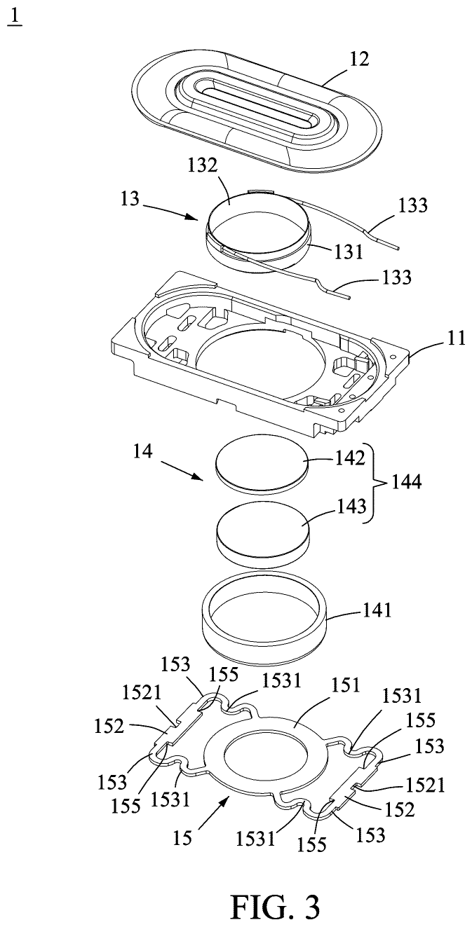

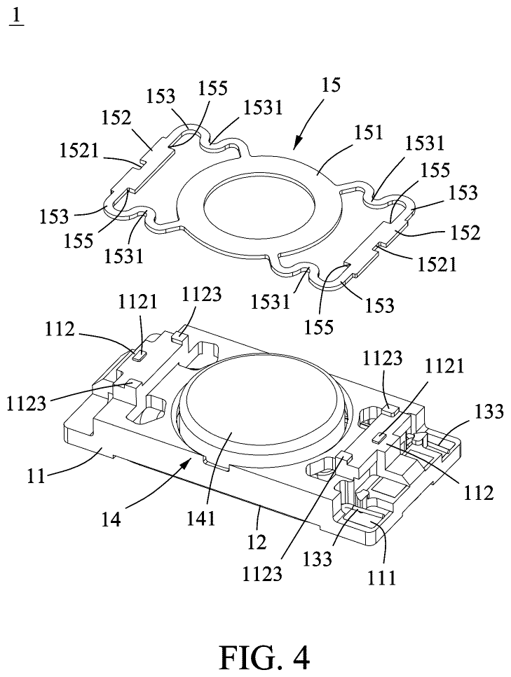

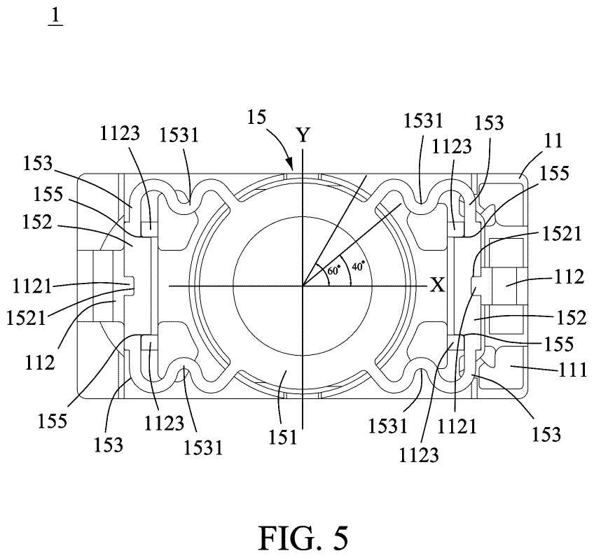

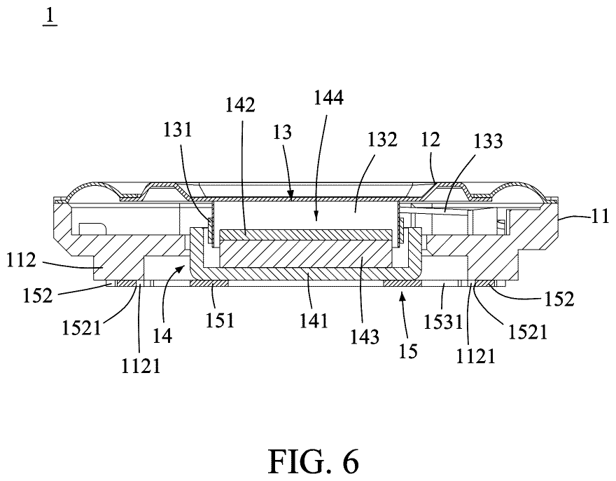

With reference to FIG. 1 to FIG. 6, as shown in the figures, the present disclosure provides a vibration damping loudspeaker 1. The vibration damping loudspeaker 1 may be a thin elongated speaker and includes: a thin elongated speaker base 11, a vibration diaphragm 12, a voice coil 13, a magnetic assembly 14 and a metal damper 15, where the voice coil 13 and the magnetic assembly 14 may be circular or racetrack-shaped.

The vibration diaphragm 12 is arranged on the top of the thin elongated speaker base 11.

The voice coil 13 is arranged on the inner side of the thin elongated speaker base 11 and is connected to the bottom of the vibration diaphragm 12, the voice coil 13 includes a coil 131, a bobbin 132 and two tinsel wires 133, where the coil 131 is wound around the bobbin 132, the tinsel wires 133 are electrically connected to the coil 131 and a conductive soldering lug 111 at the bottom of the thin elongated speaker base 11, and the top of the bobbin 132 is connected to the bottom of the vibration diaphragm 12. The tinsel wires 133 have strength and toughness, so the vibration damping loudspeaker 1 may be prevented from being broken due to overlarge amplitude during high-power operation.

The magnetic assembly 14 is arranged on the inner side of the thin elongated speaker base 11. The magnetic assembly 14 includes a magnetic base 141 and a magnetic unit 144, where the magnetic unit 144 is arranged on the magnetic base 141, and the magnetic unit 144 may be provided with a magnetic conductive plate 142 and a magnet 143. The magnet 143 is arranged on the magnetic base 141, the magnetic conductive plate 142 is arranged on the magnet 143, and the magnetic base 141 may be U-shaped iron. The voice coil 13 is movably arranged outside the magnetic unit 144 and positioned between the magnetic unit 144 and the magnetic base 141. In addition, surrounding walls of the magnetic base 141 may be changed into assembled auxiliary magnetic units, so that the magnetic base 141 may be of an internal and external double-magnetic structure.

The metal damper 15 is connected to the thin elongated speaker base 11 and the magnetic assembly 14. The metal damper 15 includes a central portion 151, two positioning portions 152 and multiple elastic arms 153, where the central portion 151 is arranged on the magnetic base 141, the positioning portions 152 are arranged at the bottoms of two short sides of the thin elongated speaker base 11 respectively, and the elastic arms 153 are arranged between the central portion 151 and the positioning portions 152 respectively. The positioning portions 152 and the elastic arms 153 are symmetrically arranged on both sides of the central portion 151, so that the magnetic assembly 14 is not directly contacted with the thin elongated speaker base 11. Four elastic arms 153 may be provided (but the number is not limited to four). The metal damper 15 may be made of a stainless steel material, a beryllium copper alloy material or a carbon steel material, preferably stainless steel.

When in use, the vibration damping loudspeaker 1 may be combined with a sound box (not shown in the figure). After external electronic signals inputted by the conductive soldering lugs 111 are received by the tinsel wires 133 of the voice coil 13, the magnetic force provided by the magnetic base 141 of the magnetic assembly 14, the magnetic conductive plate 142 and the magnet 143 is utilized to push the vibration diaphragm 12 to act by the magnetic assembly 14 in conjunction with the electromagnetic action of the voice coil 13, thereby increasing the volume of the vibration damping loudspeaker 1 during running.

When the vibration damping loudspeaker 1 runs in the above way, the thin elongated speaker base 11 is not directly contacted with the magnetic assembly 14 due to the elastic arms 153 arranged on the metal damper 15. Therefore, the elastic arms 153 may play a role of buffering between the thin elongated speaker base 11 and the magnetic assembly 14 to make the vibration frequency of the magnetic assembly 14 close to that of the thin elongated speaker base 11 but the phase opposite to that of the thin elongated speaker base, then the vibration of the thin elongated speaker base 11 may be reduced when the vibration damping loudspeaker 1 runs, thereby improving the stability of the vibration damping loudspeaker 1 during running, and further exerting a good shock-absorbing effect. In addition, the metal damper 15 may play a role of buffering between the thin elongated speaker base 11 and the magnetic assembly 14 to prevent kinetic energy generated by the magnetic assembly 14 during vibration from being transmitted back. Therefore, the vibration damping loudspeaker 1 achieves shock-absorbing and shock-isolating effects during running, which avoids discomfort of a user when using an electronic device.

In addition to the above embodiments, in one embodiment of the present disclosure, each of two sides of the bottom of the thin elongated speaker base 11 may be provided with an assembling portion 112, and the positioning portions 152 may be respectively bonded with the assembling portions 112 by gluing. In addition, each of the assembling portions 112 on the two sides of the bottom of the thin elongated speaker base 11 may be provided with a protrusion 1121, each of the positioning portions 152 may be provided with a notch 1521, and the positioning portions 152 are respectively arranged on the protrusions 1121 of the assembling portions 112 through the notches 1521. In the vibration damping loudspeaker 1 according to the present disclosure, the positioning portions 152 of the metal damper 15 may be stably arranged on the assembling portions 112 of the thin elongated speaker base 11, thereby increasing the stability of the elastic arms 153 playing a role of buffering.

In addition to the above embodiments, in one embodiment of the present disclosure, each of the assembling portions 112 on the two sides of the bottom of the thin elongated speaker base 11 may be provided with at least one auxiliary positioning column 1123, each of the positioning portions 152 may be provided with at least one auxiliary positioning notch 155, and each auxiliary positioning column 1123 may be arranged at the corresponding auxiliary positioning notch 155, so as to position each positioning portion 152 to the corresponding assembling portion 112. Therefore, glue may be applied between each positioning portion 152 and the corresponding assembling portion 112, and then each auxiliary positioning column 1123 and the corresponding auxiliary positioning notch 155 are positioned and bonded with each other, so as to adhere the metal damper 15 to the bottom of the thin elongated speaker base 11.

In addition to the above embodiments, in one embodiment of the present disclosure, the central portion 151 may be in a shape of a hollow ring, and the central portion 151 may be arranged at the bottom of the magnetic base 141. In the vibration damping loudspeaker 1 according to the present disclosure, the central portion 151 and the elastic arms 153 may be matched to prevent the thin elongated speaker base 11 from being directly contacted with the magnetic assembly 14. Therefore, the elastic arms 153 may play a role of buffering between the thin elongated speaker base 11 and the magnetic assembly 14 to absorb (consume) kinetic energy generated by the thin elongated speaker base 11 during vibration, then the vibration of the thin elongated speaker base 11 may be reduced when the vibration damping loudspeaker 1 runs, thereby improving the stability of the vibration damping loudspeaker 1 in running, further exerting a good shock-absorbing effect, and avoiding the problems of distortion such as skewing and polarization of the vibration diaphragm 12 and the voice coil 13 in high-power output.

In addition to the above embodiments, in one embodiment of the present disclosure, the central portion 151 may be in a shape of a hollow ring or a solid circle, and the metal damper 15 may be integrally formed or formed by two symmetric bodies which are connected to each other. The central portion 151 formed by the symmetric bodies may be formed by two circular arc bodies which are connected to each other or two semicircular bodies which are connected to each other. Because the weight of the metal damper 15 will affect the vibration frequency, the central portion 151 in different type may be selected according to the weight demands in actual application, and then the weight of the metal damper 15 may be adjusted to determine proper vibration frequency.

In addition to the above embodiments, in one embodiment of the present disclosure, the elastic arms 153 are mutually symmetrically arranged between the central portion 151 and the positioning portions 152 respectively, and an inclined angle between a joint of each elastic arm 153 to the central portion 151 and a horizontal axis of rectangular coordinates may be 40-60°. In the vibration damping loudspeaker 1 according to the present disclosure, the elastic arms 153 have good buffering effect, which helps to reach good balance during vibration. Therefore, the maximum shock-absorbing effect may be achieved.

In addition to the above embodiments, in one embodiment of the present disclosure, each of the elastic arms 153 may be provided with a bending portion 1531, each bending portion 1531 may be S-shaped, and one end of each elastic arm 153 is connected to the periphery of the central portion 151 while the other end of each elastic arm 153 is connected to the end part of the corresponding positioning portion 152. Therefore, in the vibration damping loudspeaker 1 according to the present disclosure, the elastic arms 153 may be stably arranged between the central portion 151 and each positioning portion 152. In addition, the longer the elastic arms 153, the larger the radian of the bending portions 1531. Alternatively, the more the number of the bending portions 1531, the more the displacement of the metal damper 15 may be increased, so that the bending portions 1531 of the elastic arms 153 may be used for adjusting the vibration frequency and amplitude (displacement) to improve the stability of the elastic arms 153 in buffering in the present disclosure.

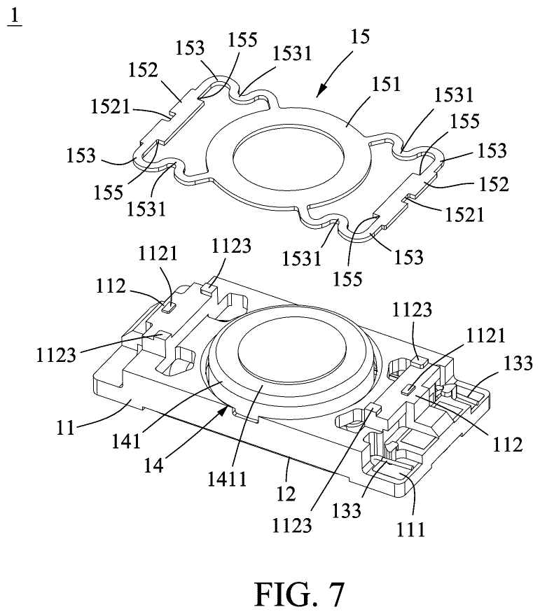

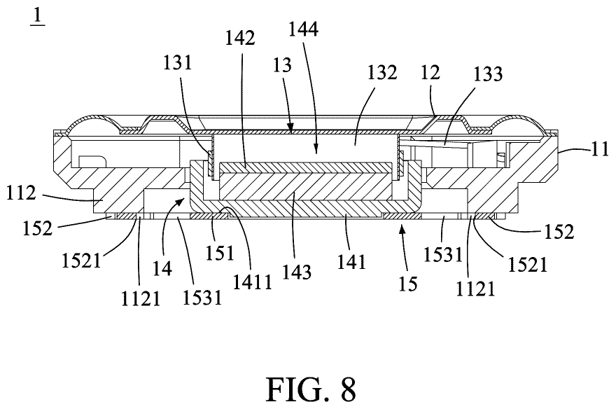

With reference to FIG. 7 and FIG. 8, as shown in the figures, in addition to the above embodiments, in one embodiment of the present disclosure, the central portion 151 may be in a shape of a hollow ring, and the bottom of the magnetic base 141 may be provided with an annular limiting portion 1411, annular steps may be formed at the bottom of the magnetic base 141 forms, and the central portion 151 is arranged on the annular limiting portion 1411. Therefore, in the vibration damping loudspeaker 1 according to the present disclosure, the central portion 151 may be easily aligned and stably attached to the magnetic base 141 by the annular limiting portion 1411, thereby improving the assembling efficiency of the metal damper 15 and the magnetic assembly 14.

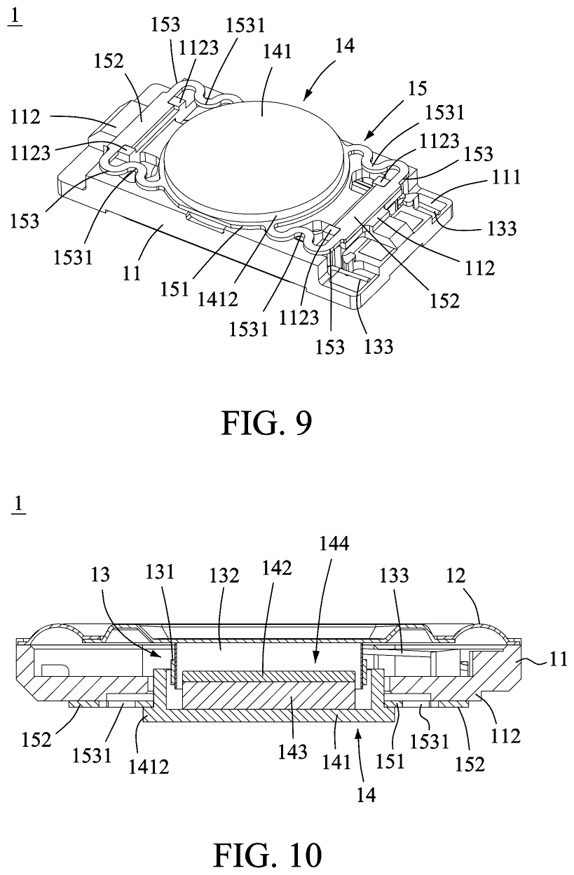

With reference to FIG. 9 and FIG. 10, as shown in the figures, in addition to the above embodiments, in one embodiment of the present disclosure, the central portion 151 may be in a shape of a hollow ring, the periphery of the bottom of the magnetic base 141 may be convexly provided with an annular extending portion 1412, and the central portion 151 may be arranged on the annular extending portion 1412. In the vibration damping loudspeaker 1 according to the present disclosure, the central portion 151 may be easily aligned and stably bonded with the magnetic base 141 by the annular extending portion 1412, thereby improving the assembling efficiency of the metal damper 15 and the magnetic assembly 14, as well as maintaining the magnetic assembly 14 at a predetermined height position at the same time.

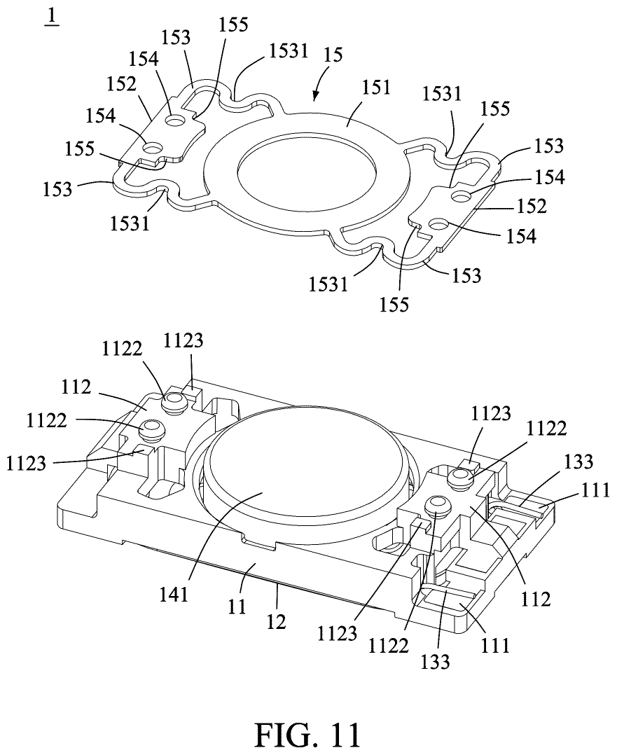

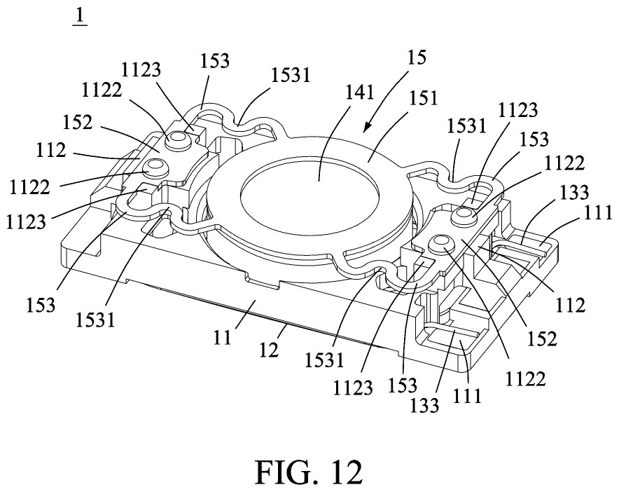

With reference to FIG. 11 and FIG. 12, as shown in the figures, in addition to the above embodiments, in one embodiment of the present disclosure, each of the assembling portions 112 on the two sides of the bottom of the thin elongated speaker base 11 may be provided with at least one positioning column 1122, each of the positioning portions 152 may be provided with at least one positioning hole 154, each positioning column 1122 may be arranged into the corresponding positioning hole 154, and each positioning portion 152 and the corresponding assembling portion 112 may be connected to each other with glue. In addition, each positioning column 1122 may be a hot melting column and may cover the periphery of the corresponding positioning hole 154 after hot melting. Moreover, each of the assembling portions 112 on the two sides of the bottom of the thin elongated speaker base 11 may be provided with at least one auxiliary positioning column 1123, each of the positioning portions 152 may be provided with at least one auxiliary positioning notch 155, and each auxiliary positioning column 1123 may be arranged to the corresponding auxiliary positioning notch 155, so as to position each positioning portion 152 to the corresponding assembling portion 112. Therefore, each positioning portion 152 and the corresponding assembling portion 112 may be positioned and bonded with each other by the corresponding positioning column 1122 and the corresponding positioning hole 154, and then positioned and bonded with each other by the corresponding auxiliary positioning column 1123 and the corresponding auxiliary positioning notch 155. When each positioning column 1122 is heated by a hot melting device, each positioning column 1122 will be melted and cover the periphery of the corresponding positioning hole 154 of the metal damper 15, so that the metal damper 15 and the thin elongated speaker base 11 may be firmly bonded. In addition, glue may be applied between each positioning portion 152 and the corresponding assembling portion 112 to fix the metal damper 15 to the thin elongated speaker base 11 in advance, and finally the metal damper 15 and the thin elongated speaker base 11 are firmly bonded by hot melting. The pre-use of glue for bonding may avoid the problem that when only hot melting is adopted for bonding, a gap will be formed between the metal damper 15 and the thin elongated speaker base 11, which causes collision between the metal damper and the thin elongated speaker base, affecting the shock-absorbing effect. Moreover, the same effect may be achieved by applying the glue between each positioning portion 152 and the corresponding assembling portion 112 after hot melting.

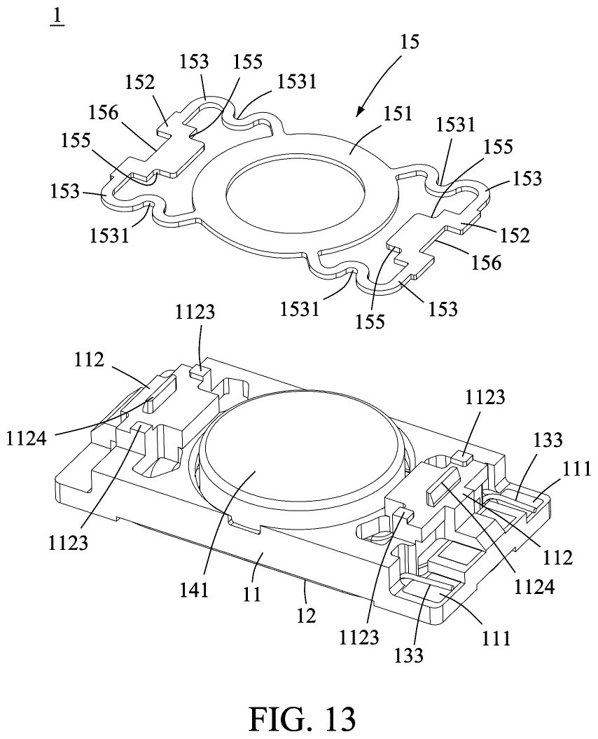

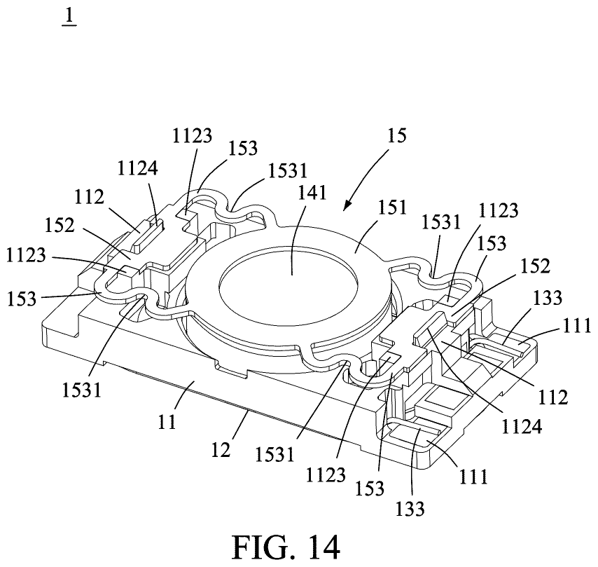

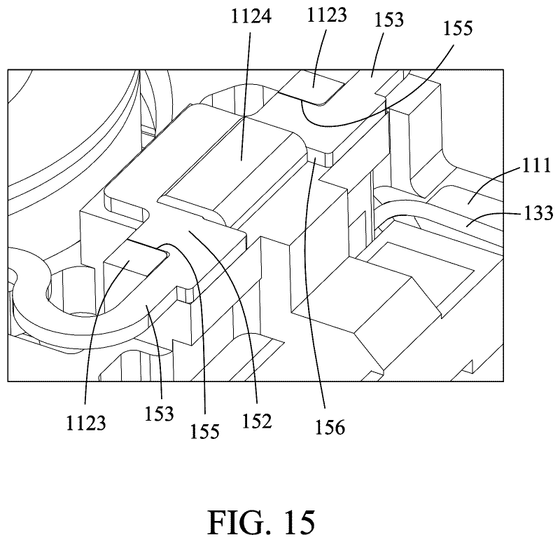

With reference to FIG. 13 and FIG. 15, as shown in the figures, in addition to the above embodiments, in one embodiment of the present disclosure, each of the assembling portions 112 on the two sides of the bottom of the thin elongated speaker base 11 may be provided with a positioning retaining wall 1124, each of the positioning portions 152 may be provided with a positioning notch 156, the positioning retaining walls 1124 may be arranged at the positioning notches 156, and each positioning portion 152 and the corresponding assembling portion 112 may be connected to each other with glue. In addition, the positioning retaining walls 1124 may be hot melting retaining walls that may be bent to quickly cover the positioning notches 156 in a large area (as shown in FIG. 15), thereby stably bonding the metal damper 15 with the thin elongated speaker base 11. Moreover, each of the assembling portions 112 on the two sides of the bottom of the thin elongated speaker base 11 may be provided with at least one auxiliary positioning column 1123, each of the positioning portions 152 may be provided with at least one auxiliary positioning notch 155, and each auxiliary positioning column 1123 may be arranged to the corresponding auxiliary positioning notch 155, so as to position each positioning portion 152 to the corresponding assembling portion 112. Therefore, each positioning portion 152 and the corresponding assembling portion 112 may be positioned and bonded with each other by the corresponding positioning retaining wall 1124 and the corresponding positioning notch 156, and then positioned and bonded with each other by the corresponding auxiliary positioning column 1123 and the corresponding auxiliary positioning notch 155. After the positioning retaining walls 1124 are heated by the hot melting device, the positioning retaining walls 1124 may be stably bent to quickly cover the positioning notches 156 in a large area, thereby stably bonding the metal damper 15 with the thin elongated speaker base 11. In addition, glue may be applied between each positioning portion 152 and the corresponding assembling portion 112 to fix the metal damper 15 to the thin elongated speaker base 11 in advance, and finally the metal damper 15 and the thin elongated speaker base 11 are firmly bonded by hot melting. The pre-use of glue for bonding may avoid the problem that when only hot melting is adopted for bonding, a gap will be formed between the metal damper 15 and the thin elongated speaker base 11, which causes collision between the metal damper and the thin elongated speaker base, affecting the shock-absorbing effect. Moreover, the same effect may be achieved by applying the glue between each positioning portion 152 and the corresponding assembling portion 112 after hot melting.

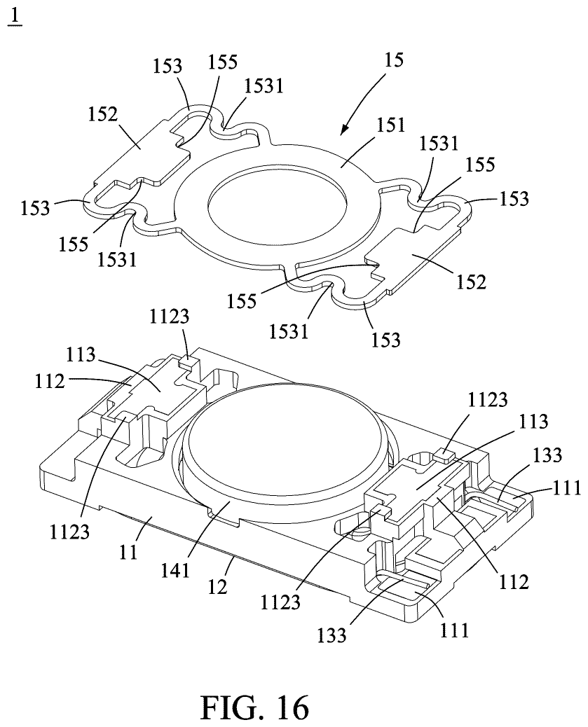

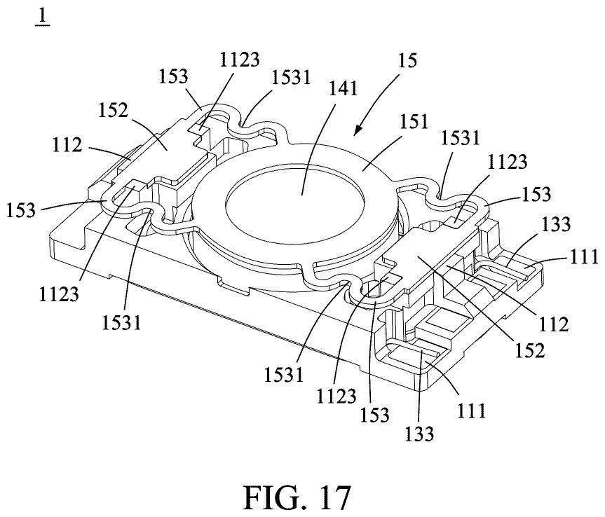

With reference to FIG. 16 and FIG. 17, as shown in the figures, in addition to the above embodiments, in one embodiment of the present disclosure, a metal sheet 113 (such as a steel sheet) may be injection-molded on each of the assembling portions 112 on the two sides of the bottom of the thin elongated speaker base 11, and each positioning portion 152 may be spot-welded on the corresponding metal sheet 113 by laser to realize complete bonding. In addition, each of the assembling portions 112 on the two sides of the bottom of the thin elongated speaker base 11 may be provided with at least one auxiliary positioning column 1123, each of the positioning portions 152 may be provided with at least one auxiliary positioning notch 155, and each auxiliary positioning column 1123 may be arranged at the corresponding auxiliary positioning notch 155, so as to position each positioning portion 152 to the corresponding assembling portion 112. In this embodiment, spot welding by laser is the best bonding mode, the metal may be completely and tightly fused together after being melted at high temperature, so it is not needed to apply glue for fixing in advance. In addition, spot welding by laser may avoid abnormal impact sound which is generated between the metal damper 15 and the thin elongated speaker base 11 and affects the shock absorption effect. Moreover, each positioning portion 152 and the corresponding assembling portion 112 may be mutually positioned and bonded by the corresponding auxiliary positioning column 1123 and the corresponding auxiliary positioning notch 155 first, so that the metal damper 15 may be spot-welded on the metal sheet 113 conveniently. Moreover, a material of each metal sheet 113 may be the same as that of each positioning portion 152, which improves the stability in the spot welding by laser.

The present disclosure is disclosed in the above with preferred embodiments, but those familiar with this technique should understand that the embodiments are only used for describing the present disclosure and should not be construed as limiting the scope of the present disclosure. It is to be noted that all changes and substitutions equivalent to the embodiments should be set to cover the scope of the present disclosure. Therefore, the scope of protection of the present disclosure shall be subject to the definition of the scope of the patent application.

What is claimed is:

1. A vibration damping loudspeaker, comprising:
a thin elongated speaker base;
a vibration diaphragm arranged on the thin elongated speaker base;
a voice coil comprising a coil, a bobbin and two tinsel wires, wherein the coil is wound around the bobbin, the tinsel wires are electrically connected to the coil, and the bobbin is connected to the vibration diaphragm;
a magnetic assembly comprising a magnetic base and a magnetic unit, wherein the magnetic unit is arranged on the magnetic base, and the voice coil is movably arranged outside the magnetic unit; and
a metal damper connected to the thin elongated speaker base and the magnetic assembly, the metal damper comprising a central portion, two positioning portions and a plurality of elastic arms, wherein the central portion is arranged on the magnetic base, the positioning portions are arranged on two sides of the thin elongated speaker base, the elastic arms are arranged between the central portion and the positioning portions, and the positioning portions and the elastic arms are symmetrically arranged on two sides of the central portion.

2. The vibration damping loudspeaker according to claim 1, wherein each of two sides of the thin elongated speaker base is provided with an assembling portion, and the positioning portions are respectively arranged at the assembling portions.

3. The vibration damping loudspeaker according to claim 1, wherein each of the two sides of the thin elongated speaker base is provided with a protrusion, each of the positioning portions is provided with a notch, and the positioning portions are respectively arranged at the protrusions of the assembling portions through the notches.

4. The vibration damping loudspeaker according to claim 1, wherein each of the two sides of the thin elongated speaker base is provided with at least one auxiliary positioning column, each of the positioning portions is provided with at least one auxiliary positioning notch, and each auxiliary positioning column is arranged at the corresponding auxiliary positioning notch.

5. The vibration damping loudspeaker according to claim 1, wherein the metal damper is made of a stainless steel material, a beryllium copper alloy material or a carbon steel material.

6. The vibration damping loudspeaker according to claim 1, wherein the central portion is in a shape of a hollow ring, and is arranged at a bottom of the magnetic base.

7. The vibration damping loudspeaker according to claim 1, wherein the central portion is in a shape of a hollow ring, a bottom of the magnetic base is provided with an annular limiting portion, and the central portion is arranged at the annular limiting portion.

8. The vibration damping loudspeaker according to claim 1, wherein the central portion is in a shape of a hollow ring, a periphery of a bottom of the magnetic base is provided with an annular extending portion, and the central portion is arranged at the annular extending portion.

9. The vibration damping loudspeaker according to claim 1, wherein the central portion is annular or solid, and the metal damper is integrally formed or formed by two symmetrical bodies which are mutually connected.

10. The vibration damping loudspeaker according to claim 1, wherein each of the elastic arms is provided with a bending portion, each bending portion is S-shaped, and one end of each elastic arm is connected to the central portion while the other end thereof is connected to the corresponding positioning portion.

11. The vibration damping loudspeaker according to claim 1, wherein an included angle between a joint of each elastic arm to the central portion and a horizontal axis of rectangular coordinates is 40-60°.

12. The vibration damping loudspeaker according to claim 1, wherein each of the two sides of the thin elongated speaker base is provided with at least one positioning column, each of the positioning portions is provided with at least one positioning hole, and each positioning column is arranged in the corresponding positioning hole.

13. The vibration damping loudspeaker according to claim 12, wherein each positioning column is a hot melting column used for covering the corresponding positioning hole.

14. The vibration damping loudspeaker according to claim 1, wherein each of the two sides of the thin elongated speaker base is provided with a positioning retaining wall, each of the positioning portions is provided with a positioning notch, the positioning retaining walls are arranged at the positioning notches, and the positioning retaining walls are hot melting retaining walls used for covering the positioning notches.

15. The vibration damping loudspeaker according to claim 1, wherein a metal sheet is injection-molded on each of the two sides of the thin elongated speaker base, and each of the positioning portions is spot-welded to the corresponding metal sheet by laser.

16. The vibration damping loudspeaker according to claim 15, wherein a material of each metal sheet is the same as that of each positioning portion.
